(19) United States
(12) Patent Application Publication
(10) Pub. No.: US 2014/0167984 A1
(43) Pub. Date: Jun. 19, 2014

(54) Pressure Value Transmitter with Redundant Pressure Value Indicator

(71) Applicants: Reima K. Holopainen, Zufikon (CH); Stefan E. Wegmann, Zurich (CH)

(72) Inventors: Reima K. Holopainen, Zufikon (CH); Stefan E. Wegmann, Zurich (CH)

(73) Assignee: JOHNSON OUTDOORS INC., Racine, WI (US)

(21) Appl. No.: 14/108,015

(22) Filed: Dec. 16, 2013

Related U.S. Application Data
(60) Provisional application No. 61/738,025, filed on Dec. 17, 2012.

(51) Int. Cl. G08C 17/02

(52) U.S. Cl. CPC G08C 17/02
USPC 340/870.07

(57) ABSTRACT

A transmitter assembly with redundant pressure value indicator for a self-contained breathing apparatus is provided. The transmitter assembly with redundant pressure value indicator includes a wireless transmitter configured to transmit gas pressure data for a gas storage tank to a dive computer. The gas pressure data is retrieved from a pressure sensor coupled to the wireless transmitter. The transmitter assembly with redundant pressure value indicator also has a visual indicator configured to indicate a gas pressure value for gas in the storage tank. The visual indicator and wireless transmitter are coupled to a control module. Further, the wireless transmitter, control module, and visual indicator share a power source.

### CROSS-REFERENCE TO RELATED PATENT APPLICATIONS

This patent application claims the benefit of U.S. Provisional Patent Application No. 61/738,025, filed Dec. 17, 2012, the entire teachings and disclosure of which are incorporated herein by reference thereto.

### FIELD OF THE INVENTION

This invention generally relates to self-contained breathing systems, and more particularly to self-contained breathing systems capable of indicating gas pressure values and/or ranges.

### BACKGROUND OF THE INVENTION

Scuba divers, emergency workers such as firefighters, airplane pilots, and even mountain climbers may carry self-contained breathing apparatus having compressed air, or breathable gas, in storage tanks. Typically, the air supply is provided to the user via a regulator of some type. Scuba divers sometimes use a mixture of compressed gases, as opposed to compressed air, which are stored in tanks and provided to the diver. Typically, the pressure of the air or gas mixture is displayed on a pressure gauge or dive computer which can be monitored by the user in order to determine the remaining amount of gas or air in the tank.

With firefighter and scuba divers in particular, the amount of remaining air in the storage tank becomes critically important to the well-being of the user. Typically, this is accomplished by a user frequently referring to an air or gas supply gauge that mounts on the end of a pressure hose extending from the storage tank regulator. However, this requires the user to locate and retrieve the gauge at the time of monitoring. For firefighters, running out of air in a burning building may result in a fatality. In the case of scuba divers, failure to adequately monitor the amount of air remaining in the tank may require the diver to ascend too quickly to the surface. Such a rapid ascent may cause serious injury or death from decompression-related injury (i.e., the bends).

Some self-contained breathing systems will include air-integrated instruments with a wireless transmitter for transmitting storage tank pressure data to some type of handheld receiver. However, in some cases, the wireless transmitter can malfunction or the power source for the wireless transmitter may be depleted, or nearly depleted, and this does not become known until the user attempts to use the breathing apparatus. Furthermore, an underwater wireless link may not always operate as intended. For example, underwater cameras with flash lamps, diving lamps with DC-to-DC converters, and diver propulsion vehicles may generate blocking noise that prevents operation of the wireless receiver. Generally, wireless air-integrated instruments do not have a redundant system, such as a manual submersible pressure gauge, and when the wireless link is blocked or inoperable, the diver has no gas pressure information. Additionally, the information transmitted to the handheld receiver is usually only visible to the immediate user and not to other nearby users.

It would be desirable to have a device that provides a clear visual indication of the amount of gas in a self-contained breathing apparatus storage tank, where the visual indication is visible to the wearer and to those nearby. The invention provides such a device. These and other advantages of the invention, as well as additional inventive features, will be apparent from the description of the invention provided herein.

### BRIEF SUMMARY OF THE INVENTION

In one aspect, embodiments of the invention provide a transmitter assembly with redundant pressure value indicator for a self-contained breathing apparatus is provided. The transmitter assembly with redundant pressure value indicator includes a wireless transmitter configured to transmit gas pressure data for a gas storage tank to a dive computer. The gas pressure data is retrieved from a pressure sensor coupled to the wireless transmitter. The transmitter assembly with redundant pressure value indicator also has a visual indicator configured to indicate a gas pressure value for gas in the storage tank. The visual indicator and wireless transmitter are coupled to a control module. Further, the wireless transmitter, control module, and visual indicator share a power source. The visual indicator may be an LED or some other source of illumination.

Further, the LED may be configured to provide illumination in two or more colors, wherein each of the two or more colors represents a distinct gas pressure range for the gas in the storage tank. But, in alternate embodiments, the LED is configured to indicate a distinct gas pressure range for the gas in the storage tank, wherein such indication is accomplished by the control module causing the LED to blink in a predetermined sequence. In certain embodiments, the relative timing of the blinks is indicative of a particular pressure value or range of pressure values.

In a further embodiment, the control module is configured to operate the visual indicator as a low-battery power alarm. Also, the wireless transmitter may be configured to transmit battery power data to the dive computer. In a further embodiment, a temperature sensor and pressure sensor are attached to the storage tank. The temperature sensor is arranged to measure the temperature of gas flowing out of the storage tank.

The nature of the wireless signal is that, typically they are sent in data packets, for example every five seconds, as continuous signal transmission is generally not feasible. A data packet may not be received or may contain an error even if there is strong coding and cyclic redundancy checking (CRC). The data packet may be lost in transmission or, in rare but proven cases, a wrong value may pass the digital CRC checking and decoding. In this case, the user may get an incorrect pressure value for the air storage tank. In embodiments of the invention, a redundant visual indicator is wired (and therefore immune to the transmission of false values) to the digital pressure sensor, and even if the pressure value that can be read from this indicator is a rough value, it makes the safety of the breathing apparatus with wireless system much higher.

In certain embodiments, the control module is configured to cause the wireless transmitter to transmit temperature data to the dive computer and to provide warning if the temperature data indicates a threshold or greater likelihood that freezing will cause the self-contained breathing apparatus to malfunction.

In another aspect, embodiments of the invention provide a method of providing data on storage tank gas pressure in a self-contained breathing apparatus. The method includes the steps of measuring a storage tank gas pressure to determine a storage tank gas pressure value, and wirelessly transmitting the measured storage tank gas pressure value to a receiver configured to display the gas pressure value on a display screen. The method also includes providing an additional visual indicator of the storage tank gas pressure, and providing a single power source for the wireless transmitting and for the additional visual indicator. In certain embodiments, the receiver is a dive computer.

In particular embodiments, the method includes measuring a temperature of the gas flowing from the storage tank, and wirelessly transmitting measured temperature values to the receiver for display on the display screen. In a further embodiment, the method includes generating an alarm when the measured temperature of the gas falls below a predetermined value that would indicate some likelihood that components of the self-contained breathing apparatus will malfunction due to freezing, wherein the alarm is provided by the visual indicator.

In more particular embodiments, the method includes generating an alarm when the gas pressure drops below a threshold level, wherein the alarm is provided by the visual indicator. The method also includes providing an additional visual indicator of the storage tank gas pressure comprises providing a source of illumination to indicate a gas pressure value or range of gas pressure values. In some aspects, the method includes providing a source of illumination in two or more colors, wherein each of the two or more colors represents a particular gas pressure value or range of gas pressure values.

In an alternate embodiment, providing a source of illumination includes providing a blinking source of illumination, wherein the number and relative timing of the blinking represents a particular gas pressure value or range of gas pressure values. In particular embodiments, the source of illumination is an LED.

A redundant visual indicator, such as an LED, can be configured so that the indicator shows the gas pressure in the storage tank using color coding or a blinking sequence when the wireless data packet is sent. This provides the user redundant information when the gas pressure value is sent wirelessly, and the user can determine when to expect the data packet information to be shown at the receiver. If there is a self-induced signal blockage caused by, for example, use of a camera flash device, then this can be identified as the cause. In conventional self-contained breathing systems, the wireless transmitters blindly transmit pressure data, and if the signal is not received, the user has no idea whether the problem is related to a transmitter malfunction, a receiver malfunction, or a blocked wireless channel.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of a diver using scuba gear that incorporates a pressure data transmitter and visual indicator, constructed in accordance with an embodiment of the invention; and

FIG. 2 is a plan view and a cross-sectional view of the visual indicator in the form of an LED, according to an embodiment of the invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Embodiments of the invention are often described hereinbelow with respect to their application to scuba diving. However, one skilled in the art will recognize that this invention is not necessarily limited to scuba diving applications. As explained above, emergency rescue workers, firefighters, mountain climbers, etc. often use some kind of self-contained breathing apparatus, and may therefore benefit from various aspects of the invention herein described.

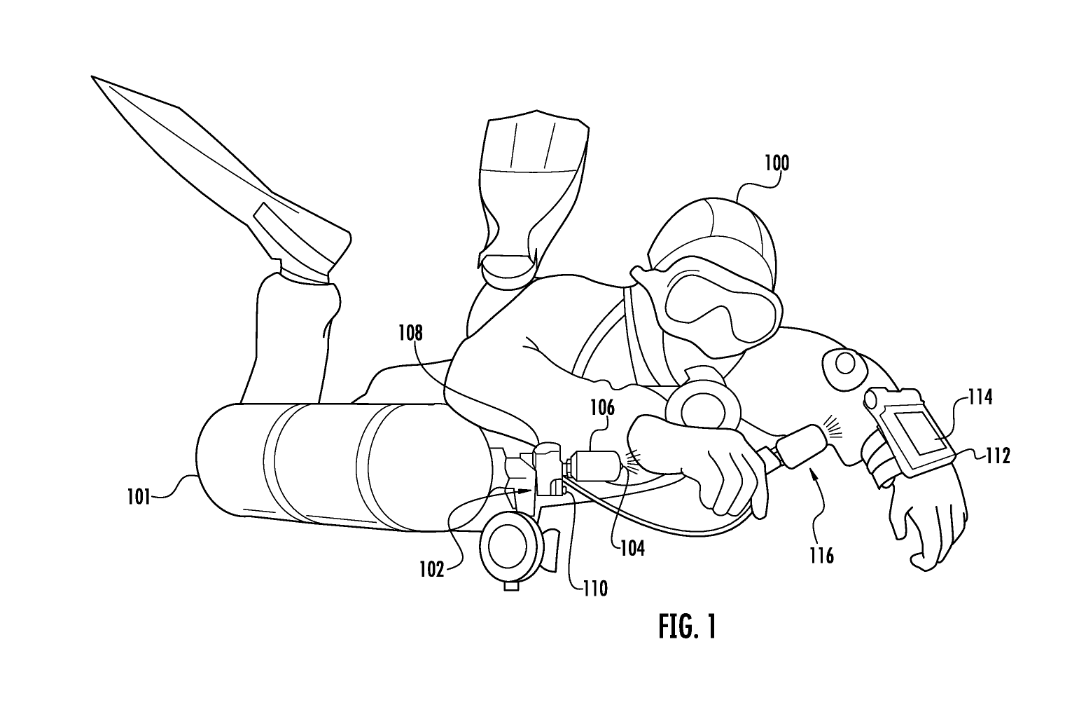

FIG. 1 is an illustration of a diver 100 using scuba gear that includes gas storage tank 101 and incorporates a wireless pressure data transmitter 102, pressure sensor 106, and visual indicator 104, constructed in accordance with an embodiment of the invention. In embodiments of the invention described herein, the wireless transmitter 102 requires a simple visual indicator 104 that is useable before and during the dive. In particular embodiments of the invention, the visual indicator 104 is powered from the transmitter main power source so that loss of the power is clearly traceable to the wireless transmitter 102 itself The visual indicator 104 is configured to be easily readable to the dive buddy during the dive. The visual indicator 104 is configured to operate continually when the pressure sensor 106 is pressurized and provides redundancy for pressure reading when the wireless link may be blocked. The pressure sensor 106 and visual indicator 104 are coupled to the wireless transmitter 102. Further, the pressure sensor 106, visual indicator 104, and wireless transmitter 102 are all coupled to a control module 108 and all powered by a shared power source, such as a battery.

One way to show the pressure value from a battery powered system with a low consumption and good readability is via the visual indicator 104. In certain embodiments, the visual indicator 104 includes a source of illumination. In some cases the source of illumination may be an LED configured to illuminate in a plurality of colors or configured as a blinking LED or LEDs. The control module 108 may be incorporated into the wireless transmitter 102 to control the transmissions from the wireless transmitter 102 to a receiver 112, for example a dive computer.

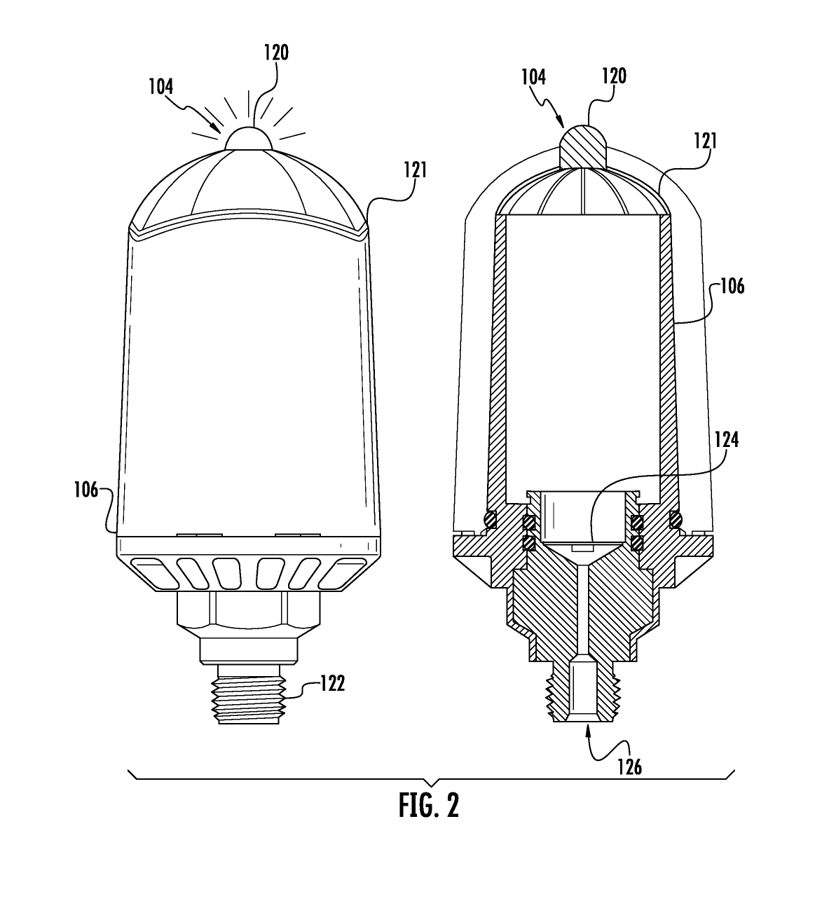

FIG. 2 shows an exemplary embodiment of the pressure sensor 106 and visual indicator 104 in which the source of illumination is one or more LEDs 120. In the embodiment shown, the pressure sensor 106 has a housing 121 and a threaded base 122, allowing the pressure sensor 106 to be screwed into a fitting attached to the storage tank 101, for example. The threaded base 122 includes a gas inlet 126 through which gas flows to a membrane 124. The membrane 124 is configured to deflect in proportion to the pressure of the gas flowing into the pressure sensor gas inlet 126. The mass of the threaded base 122 is such that it provides thermal isolation for gas within the pressure sensor 106 and in contact with the membrane 124.

The visual indicator 104 may include multiple LEDs 120 of different colors. Within the housing 121, the pressure sensor 106 may include a battery and electronics for controlling the one or more LEDs 120, specifically to control the color or the blinking thereof The visual indicator 104 may be configured to be controlled in various ways via control signals sent from the electronics within the pressure sensor housing 121. However, it is conceivable that the control module 108 could be used to control operation of the visual indicator 104. In either case, such control of the one or more LEDs 120 allows for the conveyance of relatively complex information regarding the gas pressure, temperature, or other important feature of the scuba gear.

In operation, constantly powered LEDs tend to drain their power source quickly, and large enough displays tend to require too much space from the transmitter housing. In certain embodiments, the pressure reading indication will be shown in different colors, such that operation is akin to traffic lights, for example. Independent of the pressure unit used, the color-coded pressure readings can be defined, for example, as follows:

Green—greater than 150 bar or 2175 PSI

### Yellow—75-150 bar or 1088-2175 PSI

Red—less than 75 bar or 1088 PSI

Further, the blinking of the LEDs 120, or alternate illumination source, may be sequenced so that the actual pressure value may be roughly identified. For example, one blink may identify a minimum value. In this example, one green blink equals 150 bar, and each subsequent blink may indicate 10 bar in addition to the 150 bar, e.g., three blinks equals 170 bar.

Alternatively, the blinking visual indicator 104 could take advantage of the relative blinking times to identify a more precise pressure value. Other alarms, like low battery or error at the boot up of the wireless transmitter 102, could be indicated, for example, with the red light. Therefore, the diver 100 would immediately notice before getting to the water that there is an issue and the diver 100 should not get into the water. The low temperature indication is measured directly from a temperature sensor 110, which may be adjacent to the pressure sensor 106. The location of the temperature sensor 110 guarantees the best measurable temperature value of the first stage itself. The temperature sensor 110 measures the temperature of gas flowing out from the gas storage tank 101.

The wireless transmitter 102 can be further isolated with for example a layer of rubber or neoprene to isolate it from surrounding water. The wireless transmitter 102 itself may indicate the possible freezing issue with the visual indicator 104. By sending the temperature value to the receiver 112, which is locally measuring the water temperature, the system may better detect the severity of the potential freezing issue from the temperature difference and combining it with the measured values for gas consumption. The control module 108 may be configured to cause the wireless transmitter 102 to transmit temperature data to the receiver 112 or dive computer and to provide warning if the temperature data indicates a threshold or greater likelihood that freezing will cause the self-contained breathing apparatus to malfunction.

The receiver 112 may be a dive computer with a display screen 114 worn on the diver's wrist, for example. The receiver 112 is configured to receive pressure data from the pressure sensor 106 transmitted wirelessly by the wireless transmitter 102, as well as temperature data from the temperature sensor 110 wirelessly transmitted by the wireless transmitter 102. Battery status information may also be wirelessly transmitted to the receiver 112 by the wireless transmitter 102.

For example, based on the size of, and pressure within, the gas storage tank 101, we get energy in Wh (10 L×200 bar=56 Wh). The cooling happens in a first stage that has a mass of 0.5 kg, and is made of brass (C−60 kJ/(K*kg)). By subtracting the water temperature from the temperature measured by the temperature sensor 110, we get from the equation: E=m*C*t>T, the energy absorbed by the first stage (and the thermal energy flow to the surrounding water can be calculated). From the gas consumption rate, we get energy that is currently cooling the first stage. With current energy flow to the first stage at the measured water temperature, we get an independent reference value at which the first stage will malfunction. By knowing that the middle pressure is held constant at compensated first stage, this reference value can be defined and used for the second stage as well. By measuring a few first stage and second stage combinations, the alarm level for freezing can be given for those regulator sets. The second stage heating energy from the diver 100 can be calculated by knowing that the gas temperature in the lungs is 37° C. and RH=100%. The gas from the lungs and inhaled gas will mix and exhaled gas will therefore have temperature and energy that can be made diver independent of shallow/deep breathing.

In some instances, it is advantageous to transmit wireless signals in the form of data packets, for example every five seconds. Due to the need to conserve power, it may be the case that continuous signal transmission is generally not feasible. However, data transmitted in packets may not be received or may contain an error even if there is strong coding and cyclic redundancy checking (CRC). The data packet may be lost in transmission or, in rare but proven cases, a wrong value may pass the digital CRC checking and decoding. In this case, the user may get an incorrect pressure value for the air storage tank. In embodiments of the invention, a redundant visual indicator 116 is wired (and therefore immune to the transmission of false values) to the pressure sensor 106, and even if the pressure value that can be read from this indicator is a rough value, it makes the safety and reliability of the breathing apparatus with wireless transmitter 102 much higher.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A transmitter assembly with redundant pressure value indicator for a self-contained breathing apparatus comprising:
a wireless transmitter configured to transmit, to a dive computer, gas pressure data for a gas storage tank, the gas pressure data retrieved from a pressure sensor coupled to the wireless transmitter; and
a visual indicator configured to indicate a gas pressure value for gas in the storage tank, the visual indicator and wireless transmitter coupled to a control module;
wherein the wireless transmitter, control module, and visual indicator share a power source.

2. The transmitter assembly with redundant pressure value indicator of claim 1, wherein the visual indicator is an LED.

3. The transmitter assembly with redundant pressure value indicator of claim 2, wherein the LED is configured to provide illumination in two or more colors, wherein each of the two or more colors represents a distinct gas pressure range for the gas in the storage tank.

4. The transmitter assembly with redundant pressure value indicator of claim 2, wherein the LED is configured to indicate a distinct gas pressure range for the gas in the storage tank, wherein such indication is accomplished by the control module causing the LED to blink in a predetermined sequence.

5. The transmitter assembly with redundant pressure value indicator of claim 4, wherein the relative timing of the blinks is indicative of a particular pressure value or range of pressure values.

6. The transmitter assembly with redundant pressure value indicator of claim 1, wherein the control module is configured to operate the visual indicator as a low-battery power alarm.

7. The transmitter assembly with redundant pressure value indicator of claim 6, wherein the wireless transmitter is configured to transmit battery power data to the dive computer.

8. The transmitter assembly with redundant pressure value indicator of claim 1, further comprising a temperature sensor, the temperature sensor and pressure sensor attached to the storage tank, the temperature sensor arranged to measure the temperature of gas flowing out of the storage tank.

9. The transmitter assembly with redundant pressure value indicator of claim 8, wherein the control module is configured to cause the wireless transmitter to transmit temperature data to the dive computer and to provide warning if the temperature data indicates a threshold or greater likelihood that freezing will cause the self-contained breathing apparatus to malfunction.

10. A method of providing data on storage tank gas pressure in a self-contained breathing apparatus, the method comprising the steps of:
measuring a storage tank gas pressure to determine a storage tank gas pressure value;
wirelessly transmitting the measured storage tank gas pressure value to a receiver configured to display the gas pressure value on a display screen;
providing an additional visual indicator of the storage tank gas pressure; and
providing a single power source for the wireless transmitting and for the additional visual indicator.

11. The method of claim 10, further comprising measuring a temperature of the gas flowing from the storage tank, and wirelessly transmitting measured temperature values to the receiver for display on the display screen.

12. The method of claim 11, further comprising generating an alarm when the measured temperature of the gas falls below a predetermined value that would indicate some likelihood that components of the self-contained breathing apparatus will malfunction due to freezing, wherein the alarm is provided by the visual indicator.

13. The method of claim 10, further comprising generating an alarm when the gas pressure drops below a threshold level, wherein the alarm is provided by the visual indicator.

14. The method of claim 10, wherein providing an additional visual indicator of the storage tank gas pressure comprises providing a source of illumination to indicate a gas pressure value or range of gas pressure values.

15. The method of claim 14, wherein providing a source of illumination comprises providing a source of illumination in two or more colors, wherein each of the two or more colors represents a particular gas pressure value or range of gas pressure values.

16. The method of claim 14, wherein providing a source of illumination comprises providing a blinking source of illumination, wherein the number and relative timing of the blinking represents a particular gas pressure value or range of gas pressure values.

17. The method of claim 14, wherein providing a source of illumination comprises providing an LED.

18. The method of claim 10, wherein wirelessly transmitting the measured storage tank gas pressure value to a receiver comprises wirelessly transmitting the measured storage tank gas pressure value to a dive computer.
